(19) United States
(12) Patent Application Publication
(10) Pub. No.: US 2015/0172744 A1
(43) Pub. Date: Jun. 18, 2015

(54) REMOTE CONTROL DEVICE CAPABLE OF SYNCHRONIZING SCREENS

(71) Applicant: Electronics and Telecommunications Research Institute, Daejeon (KR)

(72) Inventors: Seung-Chul Kim, Daejeon (KR); Sang-Taick Park, Seoul (KR); Jin-Woo Hong, Daejeon (KR)

(21) Appl. No.: 14/408,348

(22) PCT Filed: Jun. 24, 2013
(86) PCT No.: PCT/KR2013/005523

§ 371 Date: Dec. 16, 2014

(30) Foreign Application Priority Data
Jun. 27, 2012 (KR) 10-2012-0069292
Nov. 26, 2012 (KR) 10-2012-0134670

(51) Int. Cl. H04N 21/422; H04N 21/61; H04N 21/44

(52) U.S. Cl. CPC H04N 21/42224; H04N 21/4221; H04N 21/42209; H04N 21/44004; H04N 21/6125

(57) ABSTRACT

Disclosed is a remote control device capable of synchronizing screens. The remote control device comprises: a communication portion for communicating with a multimedia device; a touch screen on which a graphic user interface for remote-controlling the multimedia device is displayed; and a control portion for receiving through the communication portion from the multimedia device data of a plurality of images that are outputted on the screen of the multimedia device, and outputting same to the touch screen, and then transmitting remote-control data that is relevant to the multimedia device through the communication portion when inputting through the graphic user interface, thereby synchronizing the screens between the multimedia device and the remote control device.

### TECHNICAL FIELD

The present invention relates to a remote control device that remotely controls a multimedia device, and more particularly, to technology for sharing information displayed by a multimedia device with a remote control device.

### BACKGROUND ART

Technology for remotely controlling a multimedia device such as a television (TV) has been well known. A remote control device provided for the remote control is generally referred to as a remote control, which has numeric keys, letter keys, function keys, and so on. Thus, a user can remotely control the multimedia device by manipulating a key of the remote control. However, although a user can remotely control the multimedia device using the remote control, the user should check the manipulation result on a screen of the multimedia device. In addition, it is further inconvenient for a user to manipulate the remote control at a position at which it is impossible to see the screen of the multimedia device. Furthermore, even when a user wants to make a menu selection, a setting, etc. rather than a simple change of channels, the user should manipulate the remote control while checking the screen.

As technology for a remote control, the invention of a remote control capable of exchanging voice with an Internet protocol (IP) set-top box has been disclosed in Korean Registered Patent Publication No. 10-0939914. The related invention relates to a multimedia system using the IP set-top box and a voice-transmitting and receiving remote control, and the multimedia system basically employs two-way communication technology between the IP set-top box and the remote control. Specifically, the multimedia system includes an IPTV for viewing a broadcast via the Internet network, the IP set-top box that is connected to the IPTV, receives an video signal via the Internet, converts the video signal, and can transmit voice data using voice over IP (VoIP), a web camera that is connected to the IP set-top box, and monitors and transmits a compressed image via the Internet, and a radio frequency (RF) remote control that controls the IP set-top box, and can exchange voice with the IP set-top box using any one wireless network selected from among ZigBee, Bluetooth, and Institute of Electrical and Electronics Engineers (IEEE) 802.15.4. As mentioned above, the related invention allows videotelephony through a TV screen at low cost using an Internet TV. However, such a related invention does not focus on remote control that is an original purpose of the remote control. Consequently, a user still has the inconvenience of having to manipulate the remote control as mentioned above.

### DISCLOSURE

### Technical Problem

The present invention is directed to providing a remote control device enabling a user to perform remote control on a multimedia device as the user pleases even without looking at the screen of the multimedia device. The present invention is also directed to providing a remote control device enabling a user to readily perform remote control of a multimedia device for a specific function.

### Technical Solution

One aspect of the present invention provides a remote control device capable of screen synchronization including: a communicator configured to communicate with a multimedia device; a display configured to display a plurality of soft-function buttons for remotely controlling the multimedia device, and on which a touch input can be made; and a controller configured to transmit remote control data corresponding to a user input to the multimedia device through the communicator in response to the user input, receive a plurality of pieces of image data output on a screen of the multimedia device from the multimedia device through the communicator, and output the received plurality of pieces of image data to the display.

The remote control device may further include a plurality of physical-function buttons for remotely controlling the multimedia device.

The controller may change a screen of the display according to the user input, but maintain the output screen of the multimedia device as it is.

The received plurality of pieces of image data may be single-image data, and the single-image data may include all the pieces of image data output on the screen of the multimedia device but moving-picture image data.

The remote control device may further include a buffer memory in which the single-image data is stored, and when differential image data is received from the multimedia device through the communicator, the controller may generate a new single image using the received differential image data and the single-image data stored in the buffer memory, and output the generated new single image to the display.

### Advantageous Effects

The present invention can display a display screen of a multimedia device in a remote control device also in the same way. Accordingly, even by looking at only a display screen of the remote control device, a user can remotely control the multimedia device and check whether the multimedia device has been correctly controlled.

In addition, the present invention can synchronize screens of a multimedia device and a remote control device with each other except for a moving picture. Accordingly, it is possible to reduce a time taken for screen synchronization between the two devices.

Further, the present invention makes it possible to change a screen of a remote control device while maintaining a screen of a multimedia device as it is. For example, it becomes possible to expand, reduce, or scroll the screen of the remote control device, and remove or restore some elements constituting the screen from or in the screen. Accordingly, it becomes more convenient for a user to recognize content of the screen and perform control, and in particular, when there are several viewers, it is possible not to hinder viewing of other viewers.

Furthermore, the present invention facilitates control of specific functions such as channels and sound.

### DESCRIPTION OF DRAWINGS

FIG. 1 is a diagram showing a constitution of a whole system according to an exemplary embodiment of the present invention.

FIG. 2 is a diagram showing another example of a remote control device shown in FIG. 1.

FIG. 3 is a block diagram of a multimedia device for screen synchronization with a remote control device according to an exemplary embodiment of the present invention.

FIG. 4 is a block diagram of a remote control device capable of screen synchronization with a multimedia device according to an exemplary embodiment of the present invention.

FIG. 5 is a flowchart illustrating a method for screen synchronization with a remote control device performed by a multimedia device according to an exemplary embodiment of the present invention.

FIG. 6 is a flowchart illustrating a method for screen synchronization with a remote control device performed by a multimedia device according to another exemplary embodiment of the present invention.

FIG. 7 is a flowchart illustrating a method for screen synchronization with a multimedia device performed by a remote control device according to an exemplary embodiment of the present invention.

FIG. 8 is a flowchart illustrating a method for screen synchronization with a multimedia device performed by a remote control device according to another exemplary embodiment of the present invention.

### MODES OF THE INVENTION

The above-described and additional aspects of the present invention will be apparent through exemplary embodiments that will be described with reference to the accompanying drawings. The present invention will be described in detail below so that those of ordinary skill in the art can easily understand and reproduce the present invention through these embodiments.

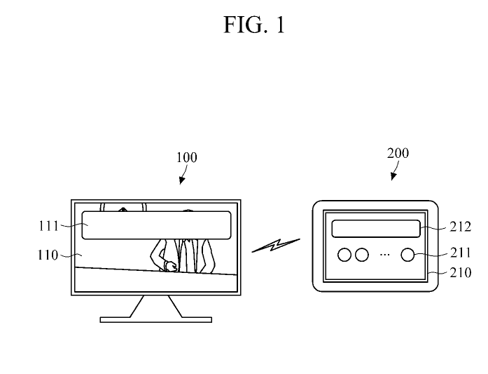

FIG. 1 is a diagram showing a constitution of a whole system according to an exemplary embodiment of the present invention.

As shown in the drawing, a whole system includes a multimedia device 100 and a remote control device 200. The multimedia device 100 may be a single-body type in which a function of processing image data and a display function are combined, or a separate type in which a display module is separated. For example, the multimedia device 100 may be the single-body type of television (TV) or the separate type of set-top box. FIG. 1 shows the multimedia device 100 in which the display module is implemented together. As shown in the drawing, the multimedia device 100 includes a display 110 for screen display. On the display 110, a moving picture or a still image can be displayed, and a graphical user interface (GUI) 111 can be displayed according to manipulation of the remote control device 200 by a user. Such a multimedia device 100 performs screen synchronization with the remote control device 200. Thus, an image displayed in the multimedia device 100 is displayed in the remote control device 200 also in the same way. However, synchronization is not performed for the moving picture. Thus, when a broadcast video or a moving picture file is played in the multimedia device 100, the video screen is not displayed in the remote control device 200.

The remote control device 200 is a device enabling a user to remotely control the multimedia device 100, and can be a device manufactured for remote control or a smart phone or a tablet personal computer (PC) in which a remote control application is installed. The remote control device 200 includes a display 210 as shown in FIG. 1. The display 210 may be a touch screen liquid crystal display (LCD) on which a touch input can be made. On the display 210, soft-function buttons 211 for remotely controlling the multimedia device 100 are displayed. Here, examples of the soft-function buttons 211 may be a power button, a channel button, a volume button, a mute button, an external input button, a menu button, an electronic program guide (EPG) button, an OK button, up/down/left/right arrow buttons, a record button, a search button, a previous channel button, a unique manufacturer function button, and so on. Thus, the user can remotely control the multimedia device 100 through manipulation of the soft-function buttons 211. Such a remote control device 200 performs a unique process necessary for screen synchronization with the multimedia device 100. Accordingly, on the display 210 of the remote control device 200, the same screen as an output screen of the multimedia device 100 is displayed, and may be displayed over the entire screen or in a designated partial area only. When the GUI 111 is displayed on the display 110 by manipulation of the user while a moving picture is played, a GUI 212 is displayed on the display 210 of the remote control device 200 also in the same way as shown in FIG. 1 by way of example. For reference, only function buttons that are not included in the GUI 212 can be implemented to be displayed on the display 210 as the soft-function buttons 211. Thus, the user can remotely control the multimedia device 100 through the GUI 212 or the soft-function buttons 211.

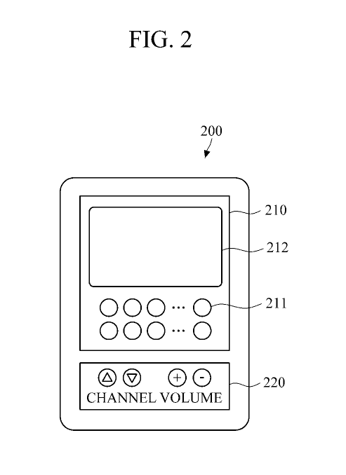

FIG. 2 is a diagram showing another example of the remote control device shown in FIG. 1.

As shown in the drawing, the remote control device 200 includes the display 210 and a manipulator 220. A screen configuration of the display 210 can be similar to or the same as the description made with reference to FIG. 1. In other words, on the display 210, the soft-function buttons 211 are displayed in the form of icons, and also the GUI 212 is displayed. The manipulator 220 is intended for manipulation of a user and includes a plurality of physical-function buttons. Like the soft-function buttons 211 displayed on the display 210, the physical-function buttons included in the manipulator 220 are used to remotely control the multimedia device 100. Examples of function buttons 213 may be a channel button, a volume button, and so on. All function buttons that are not generally included in a GUI, for example, a channel control button and a sound control button, can be implemented as the soft-function buttons 211, but when the remote control device 200 is manufactured as a dedicated device for controlling the multimedia device 100, physical-function buttons can be provided as shown in FIG. 2. In an exemplary embodiment, the soft-function buttons 211 of the display 210 and the physical-function buttons of the manipulator 220 do not overlap each other.

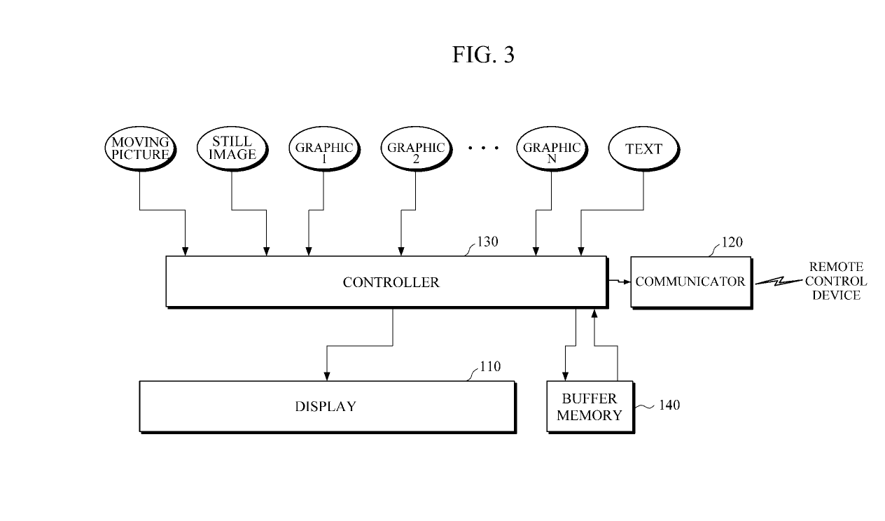

FIG. 3 is a block diagram of a multimedia device for screen synchronization with a remote control device according to an exemplary embodiment of the present invention.

As shown in the drawing, a multimedia device 100 includes a display 110, a communicator 120, and a controller 130. In case of the separate type, the display 110 for image display is not included. The display 110 is a component capable of displaying an image and can be an LCD. The communicator 120 is a component for two-way communication with a remote control device 200. For example, the communicator 120 is a communication module according to a near-field wireless communication method such as Bluetooth or near field communication (NFC). The controller 130 is a control unit for controlling the overall multimedia device 100 and includes a processor for image processing. The controller 130 performs a rendering process on multimedia data such as moving picture content, still image content, graphic content, and text, and outputs the rendered image data to the display 110, thereby displaying the rendered image data on a screen. Also, for screen synchronization, the controller 130 transmits the rendered image data to the remote control device 200. At this time, the controller 130 may transmit all the rendered image data to the remote control device 200, or transmit all the rendered image data but rendered moving-picture image data to the remote control device 200.

When at least a part of a whole image displayed on the display 110 is changed thereafter, the controller 130 also transmits the related information to the remote control device 200 to continuously achieve screen synchronization. At this time, the controller 130 may transmit image data of the whole changed screen to the remote control device 200, but when a high enough transmission rate and an image processing rate of the remote control device 200 are not supported, screen synchronization cannot be ensured. This is very true particularly in the case of a moving picture that involves a large amount of data to be processed due to its continuous change. In consideration of this, the present invention proposes a method of reducing the amount of data to be transmitted and the amount of data to be processed not by transmitting the whole changed screen to the remote control device 200 but by transmitting only changed content to the remote control device 200. Two methods will be proposed below, and operational embodiments of the multimedia device 100 will be described according to the two methods.

### Embodiment 1

A first method uses a differential image. To use a differential image, the multimedia device 100 further includes a buffer memory 140 used for storing single-image data. The method using a differential image will be described in detail below. The controller 130 generates a single image by mixing a plurality of pieces of rendered image data. Here, when there is moving-picture image data in the pieces of rendered image data, the controller 130 may generate the single image including or not including the moving-picture image data. The controller 130 outputs the generated single-image data to the display 110. Here, when the moving-picture image data is not included in the single-image, the controller 130 combines the single-image with the moving-picture image data, and then outputs the combined image data to the display 110. The controller 130 stores the generated single-image data in the buffer memory 140, and transmits the single-image data to the remote control device 200 through the communicator 120 for screen synchronization. Accordingly, screen synchronization is achieved between the multimedia device 100 and the remote control device 200.

Subsequently, the controller 130 senses a changed element among moving picture content, still image content, one or a plurality of pieces of graphic content, and text. At this time, moving picture content may be excluded from targets to be sensed. When the moving-picture image data is included in the single image, the moving-picture image data is included in the targets to be sensed, and when the moving-picture image data is not included in the single image, the moving-picture image data is not included in the targets to be sensed. When a changed element is sensed, the controller 130 performs a rendering process and mixes rendered images to newly generate a single image. The controller 130 compares the newly generated single image with the single image stored in the buffer memory 140, thereby obtaining a differential image. A technique of obtaining a differential image by comparing two images has been well known, and detailed description thereof will be omitted. When a differential image is obtained, the controller 130 transmits the differential image to the remote control device 200 through the communicator 120. Accordingly, screen synchronization is maintained between the multimedia device 100 and the remote control device 200. Also, to continuously maintain screen synchronization, the controller 130 overwrites the single-image data in the buffer memory 140 with the newly generated single-image data.

### Embodiment 2

A second method uses mixing rule information on rules for mixing images. The controller 130 mixes a plurality of pieces of rendered image data according to the mixing rule information, and outputs the mixed image data to the display 110. Here, when there is moving-picture image data in the pieces of rendered image data, the controller 130 may mix the pieces of rendered image data including the moving-picture image data according to the mixing rule information, or mix the pieces of rendered image data excluding the moving-picture image data. In the latter case, rules about moving-picture image data are not included in the mixing rule information. The controller 130 outputs the mixed image data to the display 110. Here, when the moving-picture image data is not included in the mixed image, the controller 130 combines the mixed image with the moving-picture image data, and then outputs the combined image data to the display 110. Also, the controller 130 transmits the pieces of rendered image data and the mixing rule information to the remote control device 200 through the communicator 120 for screen synchronization, and at this time, the moving-picture image data may be excluded. Accordingly, screen synchronization is achieved between the multimedia device 100 and the remote control device 200.

Subsequently, the controller 130 senses a changed element among moving picture content, still image content, one or a plurality of pieces of graphic content, text, and the mixing rule information. At this time, the moving picture content may be excluded from targets to be sensed. When the moving-picture image data is included in the mixed image, the moving-picture image data is included in the targets to be sensed, and when the moving-picture image data is not included in the mixed image, the moving-picture image data is not included in the targets to be sensed. When a changed element is sensed, the controller 130 transmits rendered images of the changed screen element and the changed mixing rule information to the remote control device 200 through the communicator 120. Accordingly, screen synchronization is continuously maintained between the multimedia device 100 and the remote control device 200.

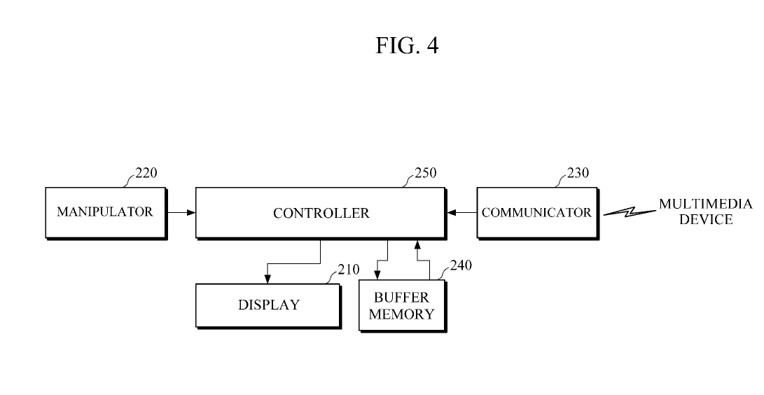

FIG. 4 is a block diagram of a remote control device for screen synchronization with a multimedia device according to an exemplary embodiment of the present invention.

As shown in the drawing, a remote control device 200 includes a display 210, a manipulator 220, a communicator 230, a buffer memory 240, and a controller 250. The display 210 may be an LCD and implemented as a touch screen LCD. The manipulator 220 is a component that enables a user to manipulate the remote control device 200 and includes the plurality of physical-function buttons described above. The communicator 230 is a component for two-way communication with a multimedia device 100. The buffer memory 240 is used to store data received from the multimedia device 100. The controller 250 is a control unit that controls the overall remote control device 200 and includes a processor for image processing. The controller 250 receives image data displayed on a screen of the multimedia device 100 from the multimedia device 100 through the communicator 230, processes the received image data according to a display method of the display 210, and outputs the processed image data to the display 210. After that, the controller 250 receives information on changed screen content from the multimedia device 100 through the communicator 230, and reconfigures a screen of the display 210 to reflect the received information. The information on the changed screen content varies according to Embodiment 1 and Embodiment 2 described above, and also a process for the controller 250 to change the display screen likewise varies. This will be described in detail below.

### Embodiment 3

Embodiment 3 is an operational embodiment of the remote control device 200 corresponding to Embodiment 1. The controller 250 receives single-image data from the multimedia device 100 through the communicator 230. As described in Embodiment 1, the single-image data may be configured to include moving-picture image data or not. The controller 250 stores the received single-image data in the buffer memory 240, processes the received single-image data according to a display method of the display 210, and outputs the processed single-image data to the display 210. Subsequently, the controller 250 receives differential image data from the multimedia device 100 through the communicator 230. The controller 250 adds the received differential image data to the single-image data stored in the buffer memory 240, thereby generating a new single image to be displayed on the display 210. The controller 250 outputs the newly generated single image to the display 210. Also, the controller 250 overwrites the single-image data in the buffer memory 240 with the newly generated single-image data. Accordingly, screen synchronization is continuously maintained between the multimedia device 100 and the remote control device 200.

### Embodiment 4

Embodiment 4 is an operational embodiment of the remote control device 200 corresponding to Embodiment 2. The controller 250 receives pieces of image data and mixing rule information from the multimedia device 100 through the communicator 230. As described in Embodiment 2, moving-picture image data may be included in or excluded from the pieces of image data transmitted by the multimedia device 100. The controller 250 stores the received pieces of image data in the buffer memory 240. Also, the controller 250 generates an image to be displayed on the display 210 by mixing the received pieces of image data according to the received mixing rule information, and outputs the generated mixed image data to the display 210. Subsequently, the controller 250 receives at least one piece of changed image data and changed mixing rule information from the multimedia device 100 through the communicator 230. The controller 250 generates an image to be displayed on the display 210 by mixing the pieces of image data stored in the buffer memory 240 and the changed image data according to the changed mixing rule information, and outputs the generated new mixed image data to the display 210. Also, the controller 250 updates the buffer memory 240 with pieces of image data constituting the new mixed image data. Accordingly, screen synchronization can be continuously maintained between the multimedia device 100 and the remote control device 200.

As described above, the remote control device 200 can synchronize its screen with a screen of the multimedia device 100. Thus, a user can remotely control and check the multimedia device 100 with ease by merely looking at the screen displayed in the remote control device 200. Further, the controller 250 changes the screen displayed on the display 210 according to a user input, but does not transmit control information for changing the screen of the multimedia device 100 to the multimedia device 100. In other words, the screen of the multimedia device 100 is maintained as it is. Examples of a screen change may be screen expansion, reduction, scrolling, etc., and also removal, restoration, etc. of some of elements constituting the screen. In screen expansion/reduction, different expansion/reduction ratios can be applied to elements constituting the screen. Here, elements constituting the screen denote individual elements, such as a background image, dialog box/button/text input windows for interaction with the user, an arrow, and a graphic image displayed according to a program execution result, which are mixed as a final image to be displayed.

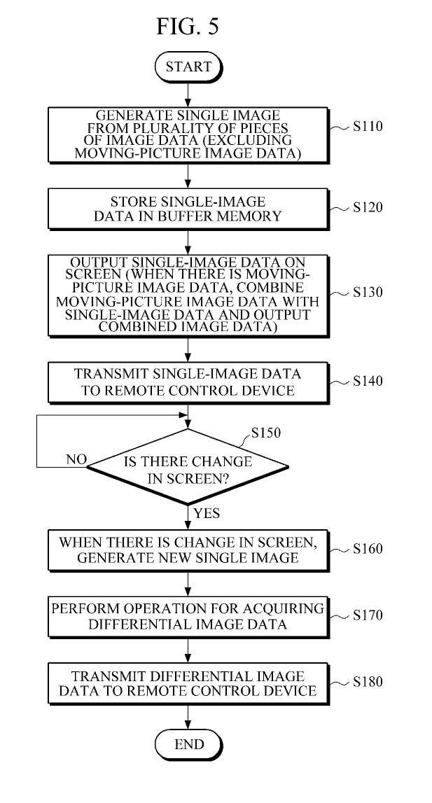

FIG. 5 is a flowchart illustrating a method for screen synchronization with a remote control device performed by a multimedia device according to an exemplary embodiment of the present invention.

The controller 130 performs a rendering process on multimedia data such as moving picture content, still image content, graphic content, and text to be displayed on a screen, and mixes pieces of rendered image data to generate a single image (S110). At this time, the moving-picture image data can be excluded from generation of the single image. The controller 130 stores the generated single-image data in the buffer memory 140 (S120), and outputs the single-image data to the display 110 (S130). When the moving-picture image data is excluded from generation of the single image, the controller 130 combines the single-image data with the moving-picture image data before output to the display 110, and outputs the combined image data to the display 110. Also, the controller 130 transmits the single-image data to the remote control device 200 through the communicator 120 for screen synchronization with the remote control device 200 (S140). Processes S120 to S140 may be performed in parallel or in a predetermined order. Subsequently, the controller 130 senses a changed element among elements that become single-image targets (S150). When a changed element is sensed, the controller 130 performs a rendering process on the corresponding element, and then generates a new single image (S160). The controller 130 compares the newly generated single image with the single image stored in the buffer memory 140, thereby performing an operation for obtaining a differential image (S170). When process S170 is finished, the controller 130 transmits the differential image data to the remote control device 200 (S180).

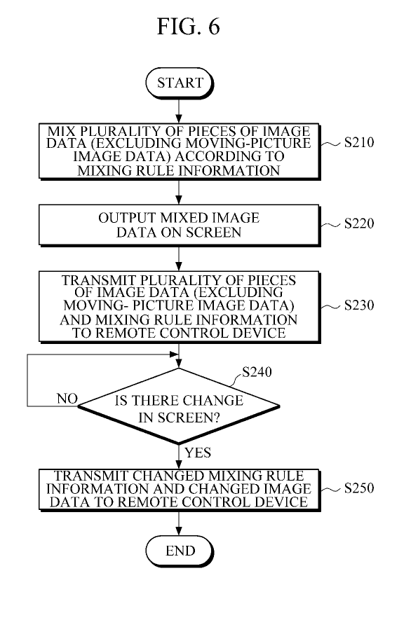

FIG. 6 is a flowchart illustrating a method for screen synchronization with a remote control device performed by a multimedia device according to another exemplary embodiment of the present invention.

The controller 130 performs a rendering process on multimedia data such as moving picture content, still image content, graphic content, and text to be displayed on a screen, mixes pieces of rendered image data according to mixing rule information (S210), and outputs the mixed image to the display 110 (S220). Also, the controller 130 transmits the mixed image data and the mixing rule information to the remote control device 200 through the communicator 120 for screen synchronization with the remote control device 200 (S230). Processes S220 and S230 may be performed in parallel or in a predetermined order. Subsequently, the controller 130 senses a changed element among moving picture content, still image content, one or a plurality of pieces of graphic content, text, and the mixing rule information (S240). At this time, moving picture content may be excluded from targets to be sensed. When a changed element is sensed, the controller 130 transmits rendered images of the changed screen element and the changed mixing rule information to the remote control device 200 through the communicator 120 (S250).

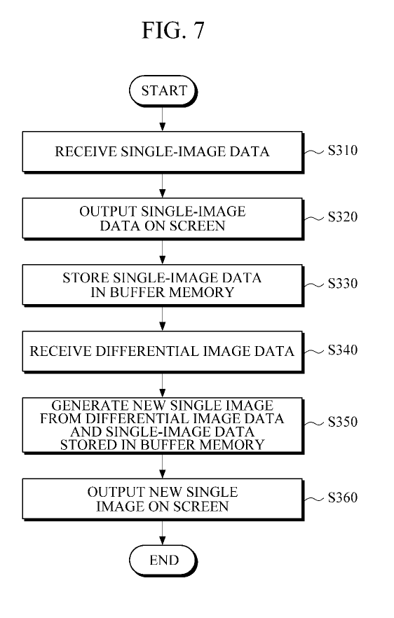

FIG. 7 is a flowchart illustrating a method for screen synchronization with a multimedia device performed by a remote control device according to an exemplary embodiment of the present invention.

The controller 250 receives single-image data through the communicator 230 (S310). The controller 250 outputs the received single-image data to the display 210 (S320), and stores the received single-image data in the buffer memory 240 (S330). Processes S320 and S330 may be performed in parallel or in a predetermined order. Subsequently, the controller 250 receives differential image data through the communicator 230 (S340). The controller 250 adds the received differential image data to the single-image data stored in the buffer memory 240 to generate a new single image (S350), and outputs the generated new single image to the display 210 (S360).

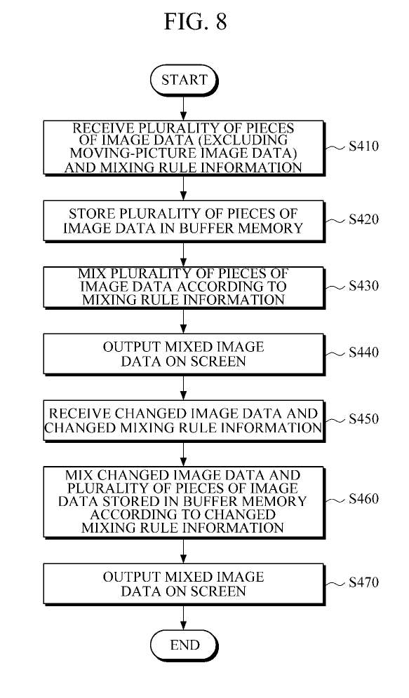

FIG. 8 is a flowchart illustrating a method for screen synchronization with a multimedia device performed by a remote control device according to another exemplary embodiment of the present invention.

The controller 250 receives a plurality of pieces of image data and mixing rule information through the communicator 230 (S410). Moving-picture image data may be excluded from the received plurality of pieces of image data. The controller 250 stores the received plurality of pieces of image data in the buffer memory 240 (S420). Also, the controller 250 mixes the received plurality of pieces of image data according to the mixing rule information (S430). Processes S420 and S430 may be performed in parallel or in a predetermined order. When mixing is finished, the controller 250 outputs the mixed image data to the display 210 (S440). Subsequently, the controller 250 receives changed image data and changed mixing rule information through the communicator 230 (S450). The controller 250 mixes the changed image data and the image data stored in the buffer memory 240 according to the changed mixing rule information (S460). When mixing is finished, the controller 250 outputs the newly mixed image data to the display 210 (S470).

While the invention has been shown and described with reference to certain exemplary embodiments thereof, it will be understood by those skilled in the art that various changes in form and details may be made therein without departing from the spirit and scope of the invention as defined by the appended claims.

1. A remote control device capable of screen synchronization, comprising:
a communicator configured to communicate with a multimedia device;
a display configured to display a plurality of soft-function buttons for remotely controlling the multimedia device, and on which a touch input is made; and
a controller configured to transmit remote control data corresponding to a user input to the multimedia device through the communicator in response to the user input, receive a plurality of pieces of image data output on a screen of the multimedia device from the multimedia device through the communicator, and output the received plurality of pieces of image data to the display.

2. The remote control device of claim 1, further comprising a plurality of physical-function buttons for remotely controlling the multimedia device.

3. The remote control device of claim 2, wherein the plurality of soft-function buttons and the plurality of physical-function buttons do not overlap each other.

4. The remote control device of claim 1, wherein the controller changes a screen of the display according to the user input, but maintains the output screen of the multimedia device as it is.

5. The remote control device of claim 4, wherein the screen change includes at least one of screen expansion, screen reduction, screen scrolling, removal of some of elements constituting the screen, and restoration of some of the elements.

6. The remote control device of claim 1, wherein the received plurality of pieces of image data are single-image data.

7. The remote control device of claim 6, wherein the single-image data includes all the pieces of image data output on the screen of the multimedia device but moving-picture image data.

8. The remote control device of claim 7, further comprising a buffer memory in which the single-image data is stored,
wherein, when differential image data is received from the multimedia device through the communicator, the controller generates a new single image using the received differential image data and the single-image data stored in the buffer memory, and outputs the generated new single image to the display.

9. The remote control device of claim 8, wherein the controller overwrites the newly generated single image data.

10. The remote control device of claim 1, wherein the controller receives mixing rule information from the multimedia device through the communicator, mixes the received plurality of pieces of image data according to the received mixing rule information, and outputs the mixed image data to the display.

11. The remote control device of claim 10, further comprising a buffer memory in which the received plurality of pieces of image data are stored,
wherein, when changed image data and changed mixing rule information is received from the multimedia device through the communicator, the controller mixes the plurality of pieces of image data stored in the buffer memory and the changed image data according to the changed mixing rule information, and outputs the mixed image data to the display.

12. The remote control device of claim 2, wherein the controller receives mixing rule information from the multimedia device through the communicator, mixes the received plurality of pieces of image data according to the received mixing rule information, and outputs the mixed image data to the display.

13. The remote control device of claim 3, wherein the controller receives mixing rule information from the multimedia device through the communicator, mixes the received plurality of pieces of image data according to the received mixing rule information, and outputs the mixed image data to the display.

14. The remote control device of claim 4, wherein the controller receives mixing rule information from the multimedia device through the communicator, mixes the received plurality of pieces of image data according to the received mixing rule information, and outputs the mixed image data to the display.

15. The remote control device of claim 5, wherein the controller receives mixing rule information from the multimedia device through the communicator, mixes the received plurality of pieces of image data according to the received mixing rule information, and outputs the mixed image data to the display.

16. The remote control device of claim 12, further comprising a buffer memory in which the received plurality of pieces of image data are stored,
wherein, when changed image data and changed mixing rule information is received from the multimedia device through the communicator, the controller mixes the plurality of pieces of image data stored in the buffer memory and the changed image data according to the changed mixing rule information, and outputs the mixed image data to the display.

17. The remote control device of claim 13, further comprising a buffer memory in which the received plurality of pieces of image data are stored,
wherein, when changed image data and changed mixing rule information is received from the multimedia device through the communicator, the controller mixes the plurality of pieces of image data stored in the buffer memory and the changed image data according to the changed mixing rule information, and outputs the mixed image data to the display.

18. The remote control device of claim 14, further comprising a buffer memory in which the received plurality of pieces of image data are stored,
wherein, when changed image data and changed mixing rule information is received from the multimedia device through the communicator, the controller mixes the plurality of pieces of image data stored in the buffer memory and the changed image data according to the changed mixing rule information, and outputs the mixed image data to the display.

19. The remote control device of claim 15, further comprising a buffer memory in which the received plurality of pieces of image data are stored,
wherein, when changed image data and changed mixing rule information is received from the multimedia device through the communicator, the controller mixes the plurality of pieces of image data stored in the buffer memory and the changed image data according to the changed mixing rule information, and outputs the mixed image data to the display.
